(19) United States
(12) Patent Application Publication
(10) Pub. No.: US 2024/0070244 A1
(43) Pub. Date: Feb. 29, 2024

(54) INFORMATION PROCESSING APPARATUS AND CONTROL METHOD

(71) Applicant: Lenovo (Singapore) Pte. Ltd., Singapore (SG)

(72) Inventors: Yuuki Matsuura, Kanagawa (JP); Eitaroh Kasamatsu, Kanagawa (JP)

(73) Assignee: Lenovo (Singapore) Pte. Ltd., Singapore (SG)

(21) Appl. No.: 18/050,470

(22) Filed: Oct. 28, 2022

(30) Foreign Application Priority Data
Aug. 26, 2022 (JP) 2022-134882

(51) Int. Cl. G06F 21/32; G06F 21/44

(52) U.S. Cl. CPC G06F 21/32; G06F 21/44; G06F 2221/2137

(57) ABSTRACT

An information processing apparatus includes: a fingerprint information acquisition unit that acquires and holds fingerprint information of a finger operating a power button with a fingerprint sensor that is integrated with the power button to boot a system; and a processor that executes authentication processing by the system based on the fingerprint information acquired by the fingerprint authentication device. At the timing when authentication processing by the system is executed by the processor, the fingerprint information acquisition unit has a first mode that holds the fingerprint information and a second mode that does not hold the fingerprint information.

### CROSS-REFERENCE TO RELATED APPLICATIONS

This application claims priority to Japanese Patent Application No. 2022-134882 filed on Aug. 26, 2022, the contents of which are hereby incorporated herein by reference in their entirety.

### BACKGROUND OF THE INVENTION

### Field of the Invention

The present invention relates to an information processing apparatus and a control method.

### Description of the Related Art

Japanese Unexamined Patent Application Publication No. 2007-179343, for example, proposes an information processing apparatus having a power button integrated with a fingerprint sensor. This information processing apparatus scans the user's fingerprint concurrently with the operation of the power button to turn on the apparatus. This apparatus is convenient because it allows a user to accomplish the tasks from the power-on to the log-in to the system with fingerprint authentication in one action (SSO: Single Sign On).

When pushing the power button, however, a user may not want to log in with fingerprint authentication. This may also lead to a security concern if the user's fingerprint is scanned every time they push the power button. Conventionally, some applications (application programs) running on the OS can disable SSO. This is a control based on the applications running on the OS, meaning that end users can control this task. Further, fingerprint information has been scanned at the time of OS boot, so that the security concern still remains.

### SUMMARY OF THE INVENTION

The present invention aims to provide an information processing apparatus having a power button integrated with a fingerprint sensor and enhancing the security, and its control method.

An information processing apparatus according to the first aspect of the present invention includes: a fingerprint information acquisition unit that acquires and holds fingerprint information of a finger operating a power button with a fingerprint sensor that is integrated with the power button to boot a system; and a processor that executes authentication processing by the system based on the fingerprint information acquired by the fingerprint information acquisition unit. At timing when authentication processing by the system is executed by the processor, the fingerprint information acquisition unit has a first mode that holds the fingerprint information and a second mode that does not hold the fingerprint information.

In the information processing apparatus, the fingerprint information acquisition unit in the first mode may execute a process of acquiring and holding the fingerprint information in response to an operation of the power button, and the fingerprint information acquisition unit in the second mode may not execute a process of acquiring the fingerprint information in response to an operation of the power button.

In the information processing apparatus, when the system transitions to a standby or stop state and the second mode is set, the fingerprint information acquisition unit may not execute a process of acquiring the fingerprint information in response to a next operation of the power button.

In the information processing apparatus, in accordance with basic input output system (BIOS) settings, the processor may execute a BIOS processing to send a control signal to set the fingerprint information acquisition unit to the second mode to the fingerprint information acquisition unit when the system transitions to a standby or stop state.

The information processing apparatus may further include; an embedded controller that instructs the processor to boot the system in response to an operation of the power button, wherein in accordance with basic input output system (BIOS) settings, the embedded controller may send a control signal to set the fingerprint information acquisition unit to the second mode to the fingerprint information acquisition unit when the system transitions to a standby or stop state.

In the information processing apparatus, when the system transitions to a standby or stop state and the first mode is set, the fingerprint information acquisition unit may acquire and hold the fingerprint information in response to a next operation of the power button.

In the information processing apparatus, in both the first mode and the second mode, the fingerprint information acquisition unit may acquire and hold the fingerprint information in response to an operation of the power button, and in the second mode, after holding the fingerprint information, the fingerprint information acquisition unit may revoke the held fingerprint information prior to timing when authentication processing of the system is executed by the processor.

In the information processing apparatus, in accordance with basic input output power system (BIOS) settings, the processor may send a control signal to instruct the fingerprint information acquisition unit to revoke the fingerprint information during a period of power on self-test (POST) executed by BIOS in response to an operation of the power button, and in the second mode, in response to acquisition of the control signal from the processor, the fingerprint information acquisition unit may revoke the held fingerprint information.

The information processing apparatus may further include; an embedded controller that instructs the processor to boot the system in response to an operation of the power button, wherein in accordance with basic input output system (BIOS) settings, the embedded controller may send a control signal to instruct the fingerprint information acquisition unit to revoke the fingerprint information prior to timing when authentication process of the system is executed by the processor, and in the second mode, in response to acquisition of the control signal from the embedded controller, the fingerprint information acquisition unit may revoke the held fingerprint information.

A control method according to the second aspect of the present invention is for an information processing apparatus including: a fingerprint information acquisition unit that acquires and holds fingerprint information of a finger operating a power button with a fingerprint sensor that is integrated with the power button to boot a system; and a processor that executes authentication processing by the system based on the fingerprint information acquired by the fingerprint information acquisition unit. The method includes: a step in which the fingerprint information acquisition unit sets to a first mode or a second mode in accordance with an incoming control signal when the system transitions to a standby or stop state; and a step in which the fingerprint information acquisition unit acquires and holds the fingerprint information in response to a next operation of the power button only when the first mode is set between the first and second modes.

A control method according to the third aspect of the present invention is for an information processing apparatus including: a fingerprint information acquisition unit that acquires and holds fingerprint information of a finger operating a power button with a fingerprint sensor that is integrated with the power button to boot a system; and a processor that executes authentication processing by the system based on the fingerprint information acquired by the fingerprint information acquisition unit. The method includes: a step in which the fingerprint information acquisition unit acquires and holds the fingerprint information in response to an operation of the power button in first and second modes, and a step in which, after holding the fingerprint information, the fingerprint information acquisition unit in the second mode revokes the held fingerprint information prior to timing when authentication process of the system is executed by the processor.

The above described aspects of present invention enhance the security of the configuration including a power button integrated with a fingerprint sensor.

### BRIEF DESCRIPTION OF THE DRAWINGS

FIG. 1 is an external view of an example of the schematic configuration of an information processing apparatus according to a first embodiment.

FIG. 2 describes an example of control when SSO is enabled and disabled in the first embodiment.

FIG. 3 is a schematic block diagram illustrating one example of the hardware configuration of the information processing apparatus according to the first embodiment.

FIG. 4 is a block diagram illustrating one example of the configuration related to finger information acquisition control according to the first embodiment.

FIG. 5 is a flowchart of one example of the scan mode setting processing according to the first embodiment.

FIG. 6 is a flowchart of one example of the fingerprint authentication control processing according to the first embodiment.

FIG. 7 describes an example of control when SSO is enabled and disabled in a second embodiment.

FIG. 8 is a block diagram illustrating one example of the configuration related to finger information acquisition control according to the second embodiment.

FIG. 9 is a flowchart of one example of the fingerprint authentication control processing according to the second embodiment.

### DETAILED DESCRIPTION OF THE INVENTION

The following describes some embodiments of the present invention, with reference to the drawings.

### First Embodiment

[Overview] First, the overview of an information processing apparatus according to the first embodiment is described below.

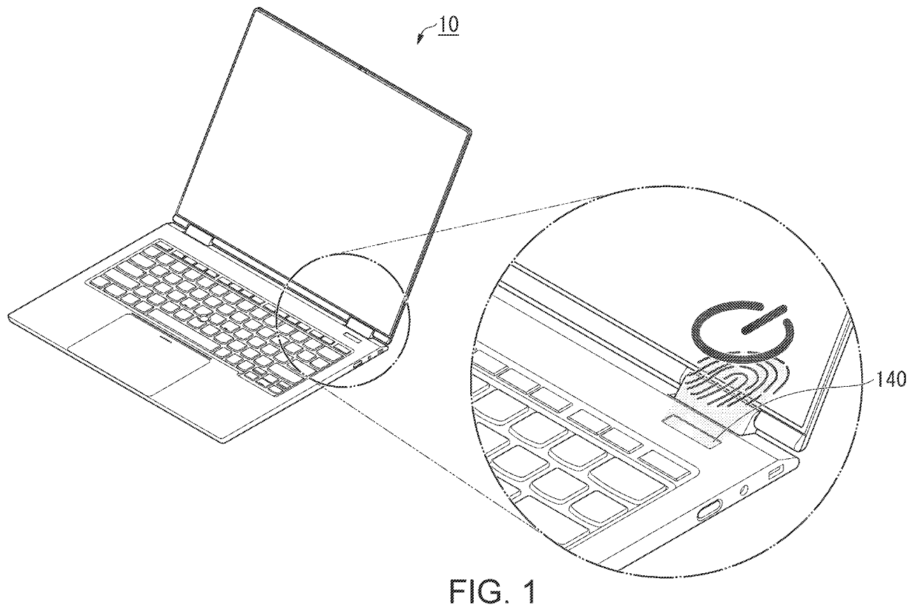

FIG. 1 is an external view of an example of the schematic configuration of the information processing apparatus according to the present embodiment.

The information processing apparatus 10 in the drawing is a laptop (clamshell-shaped) personal computer (PC).

The information processing apparatus 10 has system operating states at least: a normal operating state, a standby state, and a stop state. In the normal operating state, the power is turned on (Power On) and system processing can be executed without any particular restrictions. For example, this state corresponds to the S0 state defined by the advanced configuration and power interface (ACPI). In the standby state, at least part of the functionality of the system is restricted. For example, the standby state is a state such as standby or sleep, and may be a state corresponding to modern standby in Windows (registered trademark) or S3 (sleep), S4 (hibernation), for example, defined by ACPI. In the stop state, the power is turned off by shutting down. This state corresponds to S5 defined by ACPI. The transition of the system's operating state from the standby or stop state to the normal state is referred to as system boot. The transition of the system's operating state from the normal state to the standby state is referred to as sleep, and the transition to the stop state is referred to as shutdown.

The information processing apparatus 10 has a power button 140 as an operator that turns on the power of the apparatus (booting the system). The power button 140 is integrated with a fingerprint sensor, and is able to scan the fingerprint of a user who operates the power button 140.

For example, the information processing apparatus 10 is able to scan the user's fingerprint concurrently with the user's operation of the power button 140 to turn on the power. This allows the user to accomplish the tasks from the power-on to the login to the system with fingerprint authentication in one action. Here, this one-action function from the power-on to the login to the system with fingerprint authentication is referred to as “single sign on (SSO).”

Fingerprint authentication using the fingerprint obtained by this SSO may be applied, for example, to the authentication process when logging in to the operating system (OS), or to the authentication process when logging in to the basic input output system (BIOS). Fingerprint authentication using the fingerprint obtained by the SSO may also be applied to the authentication process for granting access to a hard disk drive (HDD) or a solid state drive (SSD). The following describes the example of applying to the authentication process when logging in to the OS.

SSO is a convenient feature for users, but a user may not want to log in with fingerprint authentication in some cases. There is also a security concern if the user's fingerprint is scanned every time they push the power button. Therefore, it is preferable that the specifications include settings to disable SSO. Some conventional apparatuses can set SSO to disable. However, these apparatuses disable SSO in the process of an application (application program) running on the OS. This leads to the problem that, although fingerprint authentication is not performed during the OS login, fingerprint is scanned when the user pushes the power button. Then, the present embodiment is configured so that the hardware (firmware) is able to set SSO to disable, and if the SSO is set to disable, fingerprint will not be scanned.

In this embodiment, settings for enabling or disabling SSO are prepared as one of BIOS settings, for example. A user can select whether to enable or disable SSO on the BIOS setting screen. When SSO is set to disable, the information processing apparatus 10 controls not to execute the process of scanning the user's fingerprint concurrently with the operation of the power button 140. Fingerprint scanning is not performed, meaning that there is no concern that scanned fingerprint information will be leaked, and this is a highly secure control method.

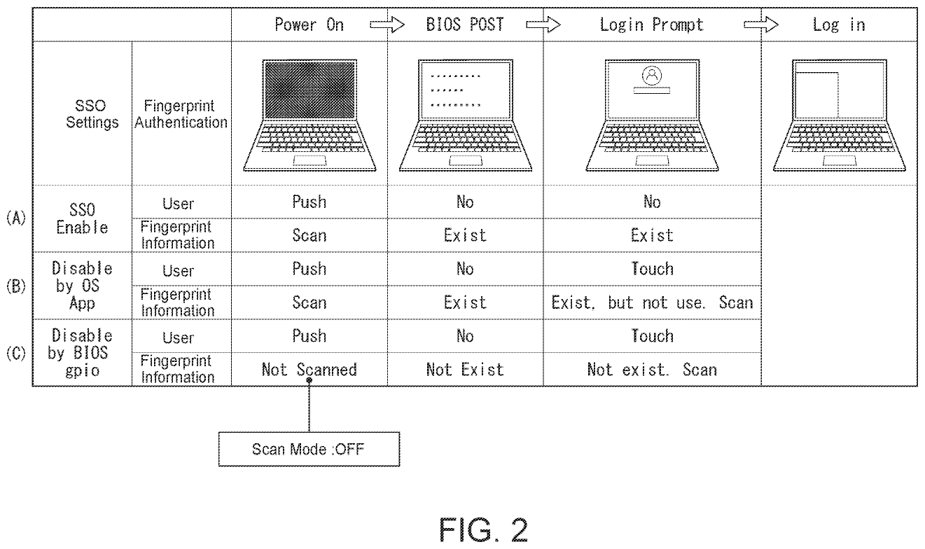

FIG. 2 describes an example of control when SSO is enabled and disabled in this embodiment. This drawing illustrates an example of control during the period from the power on to the system login.

In FIG. 2, (A) indicates an example of control when SSO is set to enable in this embodiment. When the user pushes the power button 140 for power-on, the information processing apparatus 10 scans the fingerprint of the user who pushed the power button 140, and acquires and holds the fingerprint information. The operation by the user is only one action of pushing the power button 140. After that, the information processing apparatus 10 executes POST processing of the BIOS, boots the OS, and transitions to the login screen (display of the login prompt). The information processing apparatus 10 logs in to the OS if the result of fingerprint authentication is successful. The fingerprint information continues to exist after being scanned until the system transitions to the OS login screen (display of the login prompt) and login process is performed.

In FIG. 2, (B) indicates an example of conventional control when SSO is set to disable for comparison with the present embodiment. This conventional control disables SSO in the process of an application running on the OS. Therefore, before the OS boot, the control is similar to that in (A) of FIG. 2 showing when SSO is set to enable. At the time of power-on, this conventional information processing apparatus scans the fingerprint of the user who pushed the power button to acquire and hold the fingerprint information. This fingerprint information continues to exist even after transitioning to the OS login screen (display of the login prompt) and is simply not used for fingerprint authentication when SSO is set to disable. While the login screen is displayed, the user touches the power button again (not pushing the button, but touching to scan the fingerprint). Then, the user's fingerprint is scanned, and if the fingerprint authentication is successful, the apparatus can log in to the OS.

In FIG. 2, (C) indicates an example of control when SSO is set to disable in the present embodiment. When the SSO is set to disable, the information processing apparatus 10 sets the fingerprint scan mode to off when the system transitions to the standby or stop state. This means that when the user operates the power button 140 next, the information processing apparatus 10 does not scan the fingerprint because the scan mode is off. The information processing apparatus 10 then executes the BIOS POST process, boots the OS, and transitions to the login screen (display of the login prompt), where no fingerprint information is held and exists. When the user touches (not pushes, but touches to have the fingerprint scanned) the power button 140 again on the login screen, the information processing apparatus 10 scans the user's fingerprint to acquire the fingerprint information. If the fingerprint authentication is successful, the apparatus logs in to the OS. In this way, when SSO is set to disable, the present embodiment is configured not to scan the fingerprint in response to the operation of the power button 140. There is no concern that the scanned fingerprint information will be leaked, and thus the system is highly secure.

The following describes the configuration and the processing of the information processing apparatus 10 in details.

[Hardware Configuration]

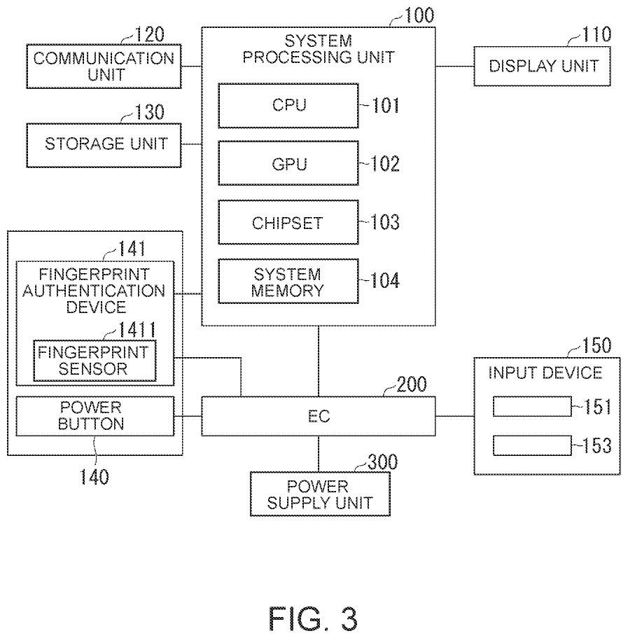

FIG. 3 is a schematic block diagram illustrating one example of the hardware configuration of the information processing apparatus 10 according to the present embodiment. In FIG. 3, like numerals indicate like components in FIG. 1. The information processing apparatus 10 includes a system processing unit 100, a display unit 110, a communication unit 120, a storage unit 130, a power button 140, a fingerprint authentication device 141, an input device 150, an embedded controller (EC) 200, and a power supply unit 300.

The display unit 110 includes a display device, such as a liquid crystal display (LCD) or an organic electro luminescence (EL) display. For example, the display unit 110 displays data (images) generated based on system processing executed by the system processing unit 100 and processing of applications running on the system processing.

The communication unit 120 is communicatively connected to other devices via a wireless or wired communication network to transmit and receive various types of data. For example, the communication unit 120 includes a wired LAN interface such as Ethernet (registered trademark) or a wireless LAN interface such as Wi-Fi (registered trademark).

The storage unit 130 includes storage media such as hard disk drive (HDD), solid state drive (SSD), random access memory (RAM), and read only memory (ROM). The storage unit 130 stores various programs such as operating systems (OSs), device drivers, and applications, as well as various other data acquired through the operation of the programs.

The power button 140 outputs an operation signal to the EC 200 in response to user operation (e.g., pushing). The power button 140 is configured integrally with the fingerprint sensor 1411. The fingerprint sensor 1411 has a fingerprint-scanned face that is a surface of the power button 140 operated by the user (e.g., the surface that is pushed by the user). The fingerprint authentication device 141 scans the fingerprint of a user's finger with the fingerprint sensor 1411 when the user operates the power button 140 to acquire fingerprint information (the scan data). The fingerprint authentication device 141 also has an internal memory and holds the acquired fingerprint information.

The input device 150 is an input unit that accepts user's input, and includes a keyboard 151 and a touchpad 153, for example. The input device 150 receives the operation to the keyboard 151 and touchpad 153 and accordingly outputs an operation signal, indicating the type of the operation, to the EC 200.

The EC 200 is a microcontroller (embedded controller) that includes a central processing unit (CPU), a RAM, a ROM, and an input/output (I/O) logic circuit. The CPU of the EC 200 reads a control program (firmware) stored in advance in its own ROM, and executes the read control program to implement its functions. The EC 200 operates independently of the system processing unit 100 to control the operation of the system processing unit 100 and manage its operating state. The EC 200 is connected to the power button 140, the fingerprint authentication device 141, the input device 150, the power supply unit 300, and the like.

For example, the EC 200 communicates with the power supply unit 300 to acquire information on the state of the battery (e.g., remaining capacity) from the power supply unit 300, and output a control signal to the power supply unit 300 to control the supply of power according to the operating status of each part of the information processing apparatus 10. The EC 200 also acquires an operation signal from the power button 140, and outputs a boot instruction signal to boot the system to the system processing unit 100 based on the acquired operation signal (such as a power-on signal). The EC 200 also acquires an operation signal from the input device 150 and outputs the acquired operation signals that are related to the processing of the system processing unit 100 to the system processing unit 100.

The power supply unit 300 supplies power to various parts of the information processing apparatus 10 according to their operating states. The power supply unit 300 includes a DC (direct current)/DC converter. The DC/DC converter converts the voltage of the DC power supplied from an AC (alternate current)/DC adapter or a battery (battery pack) into the voltage required at each part. The power with the voltage converted by the DC/DC converter is then supplied to each part via the corresponding power supply system. For example, the power supply unit 300 supplies power to each unit via the corresponding power supply system based on a control signal input from the EC 200.

The system processing unit 100 includes a CPU 101, a graphic processing unit (GPU) 102, a chipset 103, and a system memory 104, and executes processing based on the BIOS and OS and other processing for various applications running on the OS and device drivers.

The CPU 101 executes processes based on the BIOS programs, processes based on the OS programs, and processes based on applications running on the OS.

The GPU 102 is connected to the display unit 110. The GPU 102 executes image processing under the control of the CPU 101 to generate display data. The GPU 102 outputs the generated display data to the display unit 110.

The chipset 103 has a function as a memory controller and a function as an I/O controller, for example, and controls the input/output of data processed by the CPU 101 and the GPU 102. For example, the chipset 103 controls reading and writing of data at the system memory 104 or the storage unit 130 in accordance with the processing of the CPU 101 and GPU 102. The chipset 103 is also connected to the communication unit 120, the storage unit 130, the fingerprint authentication device 141, and the like, and controls the data input/output with them.

The system memory 104 is used as a reading area for programs executed by the CPU 101 and as a work area for writing processing data.

Note that the CPU 101, the GPU 102, and the chipset 103 may be configured as one integrated processor, or may be partially or individually configured as individual processors.

[Configuration Related to Fingerprint Information Acquisition Control]

Next, the following describes in detail the configuration related to fingerprint information acquisition control when SSO is enabled and disabled.

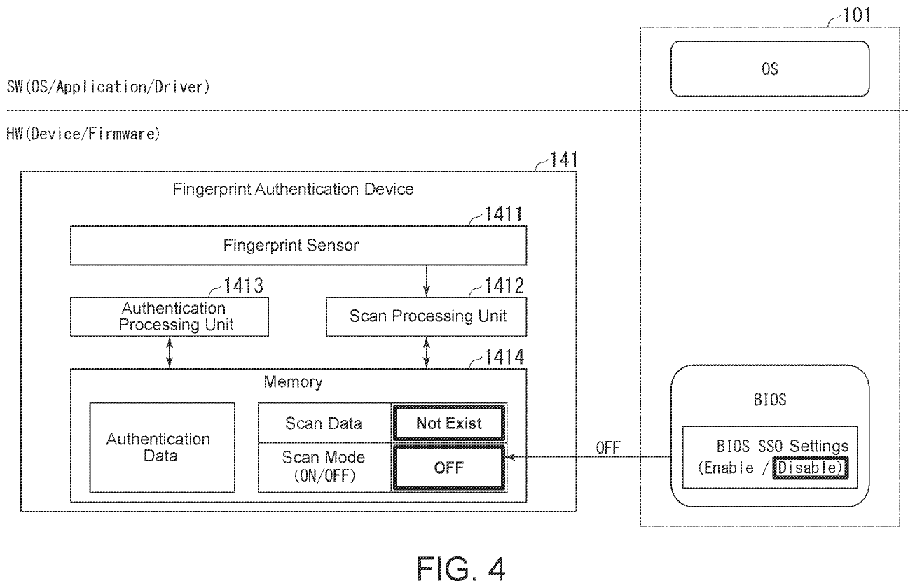

FIG. 4 is a block diagram illustrating one example of the configuration related to finger information acquisition control according to the present embodiment. The information processing apparatus 10 controls the acquisition of fingerprint information in accordance with SSO settings at the hardware (device, firmware, etc.) level, not at the software level by the OS or applications running on the OS and drivers. Control at the hardware level refers to, for example, control using the BIOS and the fingerprint authentication device 141.

The fingerprint authentication device 141 includes the fingerprint sensor 1411, a scan processing unit 1412, an authentication processing unit 1413, and a memory 1414. The fingerprint sensor 1411 is a capacitive fingerprint sensor, for example, that scans the fingerprint of a finger that is in contact with the operating surface of the power button 140 to acquire the fingerprint information.

The scan processing unit 1412 performs on/off control of fingerprint scanning processing by the fingerprint sensor 1411, and control of storing acquired fingerprint information in the memory 1414, for example. For example, the scanning process unit 1412 controls whether or not to execute the fingerprint scanning process by the fingerprint sensor 1411 based on the scan mode settings stored in the memory 1414.

Specifically, when the setting of the scan mode is on, the scan processing unit 1412 controls the fingerprint sensor 1411 to execute fingerprint scanning process to acquire fingerprint information. For example, when the user operates (e.g., pushes) the power button 140, the scanning processing unit 1412 executes the process of controlling the fingerprint sensor 1411 to scan the fingerprint of the user who pushed the power button 140 to acquire the fingerprint information. The scanning process unit 1412 then stores the acquired fingerprint information as scan data in the memory 1414.

When the setting of the scan mode is off, the scan processing unit 1412 controls the fingerprint sensor 1411 not to execute fingerprint scanning process to acquire fingerprint information. For example, when the user operates (e.g., pushes) the power button 140, the scanning processing unit 1412 controls the fingerprint sensor 1411 not to scan the fingerprint of the user who pushed the power button 140. That is, the scanning processing unit 1412 does not execute the process of acquiring the fingerprint information of the user who pushed the power button 140.

Thus, in the present embodiment, when the scan mode is on (an example of a first mode), the fingerprint authentication device 141 executes the process of acquiring and holding fingerprint information in response to a user's operation of the power button 140. When the scan mode is off (an example of a second mode), the fingerprint authentication device 141 does not execute the process of acquiring fingerprint information in response to a user's operation of the power button 140.

The scan mode is set based on the BIOS processing, for example. For example, in accordance with the BIOS settings, the CPU 101 executes the BIOS processing to send a control signal to set the scan mode to the fingerprint authentication device 141 when the system transitions from the normal state to the standby or stop state.

Specifically, when SSO is set to disable in the BIOS settings, the CPU 101 executes the BIOS processing to transmit a control signal to turn the scan mode off when the system transitions from the normal operating state to the standby or stop state. This sets the scan mode of the fingerprint authentication device 141 to off. When the scan mode is set to off, the fingerprint authentication device 141 does not execute the process of acquiring fingerprint information in response to the next operation of the power button 140.

When SSO is set to enable in the BIOS settings, the CPU 101 executes the BIOS processing to transmit a control signal to turn the scan mode on when the system transitions from the normal operating state to the standby or stop state. This sets the scan mode of the fingerprint authentication device 141 to on. When the scan mode is set to on, the fingerprint authentication device 141 executes the process of acquiring and holding fingerprint information in response to the next operation of the power button 140.

In other words, when SSO is set to enable (scan mode is set to on) in the BIOS settings, fingerprint information (scan data) exists in the fingerprint authentication device 141 at the timing of the authentication processing at the OS login that is executed by the CPU 101. In contrast, when SSO is set to disable (scan mode is set to off), no fingerprint information (scan data) exists from the operation of the power button 140 to the execution of the authentication processing for the OS login.

The authentication processing unit 1413 executes fingerprint authentication processing based on the fingerprint information (scan data) acquired by the fingerprint sensor 1411. For example, the memory 1414 stores the fingerprint information of users registered in advance as authentication data. The authentication processing unit 1413 performs fingerprint authentication processing by comparing the fingerprint information (scan data) acquired by the fingerprint sensor 1411 with the pre-registered user fingerprint information. The authentication processing unit 1413 then outputs the authentication result (authentication success or failure).

[Operation for Scan Mode Setting]

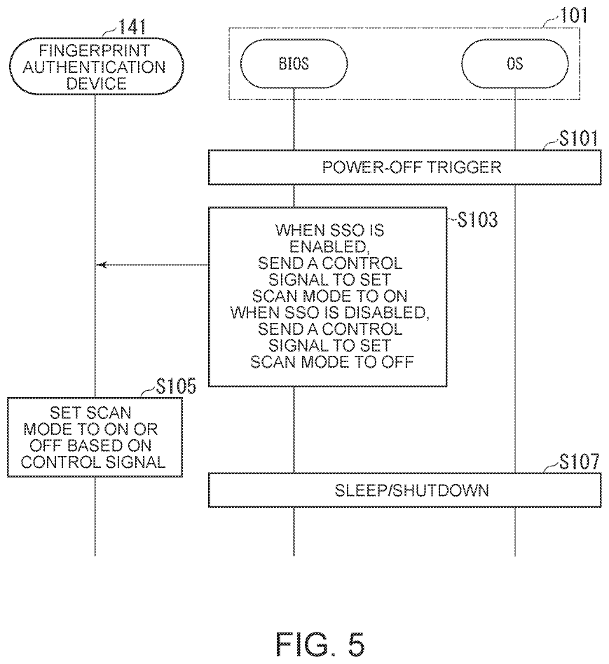

Next, referring to FIG. 5, the following describes the operation of setting the scan mode of the fingerprint authentication device 141 through the BIOS processing executed by the CPU 101. FIG. 5 is a flowchart of one example of the scan mode setting process according to the present embodiment.

(Step S101) When receiving a power-off trigger, the CPU 101 proceeds to step S103. The power-off trigger includes an instruction to shift an OS function to a standby state (e.g., to sleep) and an instruction to shutdown.

(Step S103) The CPU 101 (BIOS) sends a control signal to the fingerprint authentication device 141 to set a scan mode based on the BIOS settings. For example, when SSO is set to enable in the BIOS settings, the CPU 101 (BIOS) sends a control signal to set the scan mode to on. When SSO is set to disable in the BIOS settings, the CPU 101 (BIOS) sends a control signal to set the scan mode to off. Then the procedure shifts to step S105.

(Step S105) The fingerprint authentication device 141 acquires the control signal for setting the scan mode transmitted from the CPU 101 (BIOS) in step S103, and sets the scan mode based on the acquired control signal. When acquiring a control signal for setting the scan mode to on, the fingerprint authentication device 141 sets the scan mode to on. When acquiring a control signal for setting the scan mode to off, the fingerprint authentication device 141 sets the scan mode to off. Then the procedure shifts to step S107.

(Step S107) The CPU 101 (BIOS and OS) executes sleep processing or shutdown processing, and transitions to the standby state or stop state.

[Operation of Fingerprint Authentication Control]

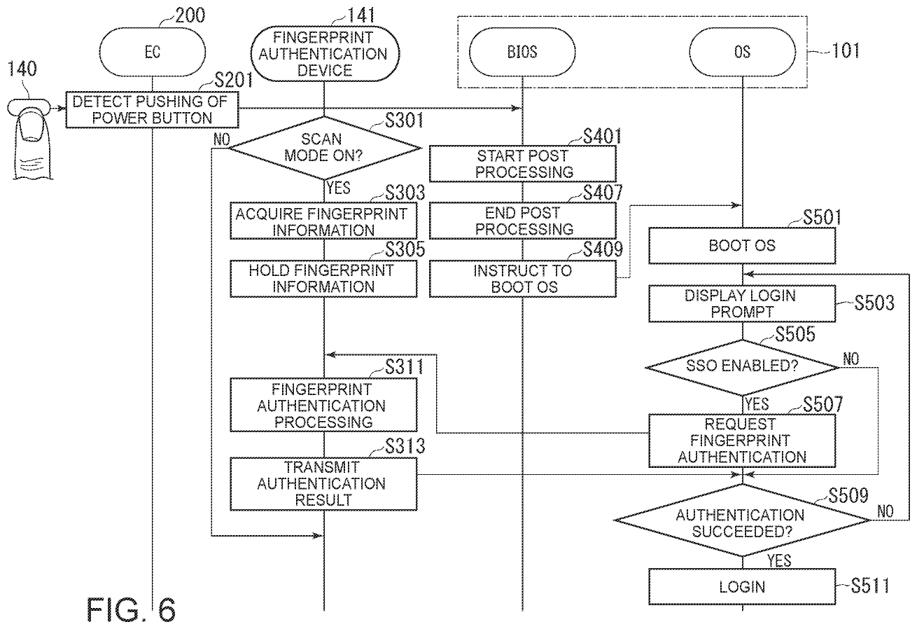

Referring next to FIG. 6, the following describes the operation of fingerprint authentication control processing in the information processing apparatus 10 when the SSO is enabled and disabled. FIG. 6 is a flowchart of one example of the fingerprint authentication control processing according to the present embodiment.

(Step S201) When the user pushes the power button 140, the power button 140 sends an operation signal to the EC 200 in accordance with the user operation (e.g., pushing). When the EC 200 acquires the operation signal from the power button 140, it detects the pushing of the power button 140. Then the EC 200 notifies the BIOS executed by the CPU 101 of a boot signal instructing booting of the system.

(Step S301) The fingerprint authentication device 141 determines whether the scan mode is set to on or not, and if the setting of the scan mode is on, the procedure shifts to step S303. When the setting of the scan mode is off, the fingerprint authentication device 141 does not execute the fingerprint scan processing by the fingerprint sensor 1411 (does not acquire fingerprint information).

(Step S303) The fingerprint authentication device 141 scans the fingerprint of the user who pushed the power button 140 with the fingerprint sensor 1411 to acquire fingerprint information. Then the procedure shifts to step S305.

(Step S305) The fingerprint authentication device 141 stores the fingerprint information (scan data) acquired in step S303 in the memory 1414.

(Step S401) When acquiring the boot signal from the EC 200, the CPU 101 boots the BIOS and starts power on self-test (POST) processing.

(Step S407) When the POST processing by the BIOS ends, the CPU 101 proceeds to step S409.

(Step S409) The CPU 101 instructs the BIOS to boot the OS.

(Step S501) The CPU 101 executes the OS program based on the boot instruction from the BIOS to boot the OS.

(Step S503) In accordance with the OS boot processing, the CPU 101 changes the display of the display unit 110 to a login screen (display of a login prompt).

(Step S505) Next, the CPU 101 executes the OS processing to determine whether or not SSO is enabled. When the CPU 101 determines that SSO is enabled (YES), the procedure proceeds to step S507. When the CPU 101 determines that SSO is disabled (NO), the procedure proceeds to step S509.

(Step S507) The CPU 101 executes the OS processing to transmit a request signal requesting the execution of fingerprint authentication processing to the fingerprint authentication device 141.

(Step S311) When receiving the request signal requesting the execution of fingerprint authentication processing, the fingerprint authentication device 141 executes the fingerprint authentication processing. For example, the authentication processing unit 141 executes the fingerprint authentication processing by comparing the fingerprint information (scan data) acquired by the fingerprint sensor 1411 with the pre-registered user fingerprint information.

(Step S313) The fingerprint authentication device 141 transmits the authentication result (authentication success or failure) by the fingerprint authentication processing in step S311 to the CPU 101.

(Step S509) The CPU 101 executes the OS processing to determine whether or not the login authentication has succeeded by fingerprint authentication or authentication means other than fingerprint authentication. For example, the CPU 101 executes the OS processing to acquire the authentication result (authentication success or failure) by the fingerprint authentication processing transmitted from the fingerprint authentication device 141 in step S313, and determines whether the login authentication was successful or not based on the acquired authentication result. Specifically, the CPU 101 determines that the login authentication has succeeded if the authentication result acquired from the fingerprint authentication device 141 indicates an authentication success. The CPU 101 determines that the login authentication has failed if the authentication result acquired from the fingerprint authentication device 141 indicates an authentication failure.

The CPU 101 also determines that the login authentication has succeeded if the authentication result by an authentication means other than fingerprint authentication indicates an authentication success. The CPU 101 determines that the login authentication has failed if the authentication result by an authentication means other than fingerprint authentication indicates an authentication failure. The authentication means other than fingerprint authentication includes means using password authentication, face authentication, and hardware tokens.

If the CPU 101 determines that the login authentication has succeeded through the OS processing (step S509: YES), the procedure proceeds to step S511. If the CPU 101 determines that the login authentication has failed or if no authentication result was obtained (step S509: NO), the procedure returns to step S503 to continue the state of waiting for login authentication on the login screen (display of login prompt).

(Step S511) If the CPU 101 determines that the login authentication has succeeded in step S509, the CPU 101 logs into the OS and transitions to the normal operation state.

### Summary of the First Embodiment

As described above, the information processing apparatus 10 according to the present embodiment includes: the fingerprint authentication device 141 (an example of a fingerprint information acquisition unit) that acquires and holds fingerprint information of a finger that operates the power button 140 with the fingerprint sensor 1411 integrated with the power button 140 to boot a system; and a CPU 101 (an example of a processor) that executes authentication processing (e.g., login authentication processing) by the system based on the fingerprint information acquired by the fingerprint authentication device 141. The fingerprint authentication device 141 has a first mode that holds fingerprint information and a second mode that does not hold fingerprint information at the timing when the authentication processing by the system is executed by the CPU 101. In the present embodiment, the scan mode of the fingerprint authentication device 141 is set to on in the first mode and off in the second mode.

This allows the information processing apparatus 10, which has the configuration of the power button 140 integrated with the fingerprint sensor 1411, to switch between the mode of holding the fingerprint information and the mode of not holding the fingerprint information when the authentication processing by the system is executed, thereby enhancing the security.

For example, when the scan mode is set to on, the fingerprint authentication device 141 executes the process of acquiring and holding fingerprint information in response to the operation of the power button 140. When the scan mode is set to off, the fingerprint authentication device 141 does not execute the process of acquiring fingerprint information in response to the operation of the power button 140.

In this way, when fingerprint information is not needed, the information processing apparatus 10 does not acquire fingerprint information by setting the scan mode to off, and thus enhances the security.

In an example, when the system transitions to the standby or stop state and the scan mode is set to off, the fingerprint authentication device 141 does not execute the process of acquiring fingerprint information in response to the next operation of the power button 140.

This allows the information processing apparatus 10 not to acquire fingerprint information when no fingerprint information is needed.

Specifically, in accordance with the BIOS settings (e.g., SSO is set to disable), the CPU 101 executes the BIOS processing to send a control signal to set the scan mode to off to the fingerprint authentication device 141 when the system transitions to the standby or stop state.

This allows the information processing apparatus 10 not to acquire fingerprint information by changing the BIOS settings when no fingerprint information is needed.

The information processing apparatus 10 also includes the EC 200 (embedded controller) that instructs the CPU 101 to boot the system in response to the operation of the power button 140. The EC 200 may send a control signal to the fingerprint authentication device 141 based on the BIOS setting (e.g., SSO is set to disable) to set the scan mode to off when the system transitions to the standby or stopped state.

This also allows the information processing apparatus 10 to set the scan mode to off under the control of the EC 200 instead of the BIOS, so as not to acquire fingerprint information when it is not needed.

When the system transitions to the standby or stop state and the scan mode is set to on, the fingerprint authentication device 141 acquires fingerprint information in response to the next operation of the power button 140.

This allows the information processing apparatus 10, which has the configuration of the power button 140 integrated with the fingerprint sensor 1411, to perform the tasks from the power-on to the login to the system by fingerprint authentication in one action.

The control method for the information processing apparatus 10 according to the present embodiment includes: a step in which the fingerprint authentication device 141 sets to the first mode (e.g., scan mode on) or the second mode (e.g., scan mode off) in response to an incoming control signal when the system transitions to the standby or stop state; and a step in which the fingerprint authentication device 141 acquires and holds fingerprint information in response to the next operation of the power button 140 only when the first mode is set between the first and second modes.

This allows the information processing apparatus 10, which has the configuration of the power button 140 integrated with the fingerprint sensor 1411, to switch between the mode of holding the fingerprint information and the mode of not holding the fingerprint information when the authentication processing by the system is executed, thereby enhancing the security.

### Second Embodiment

Next, the following describes a second embodiment of the present invention.

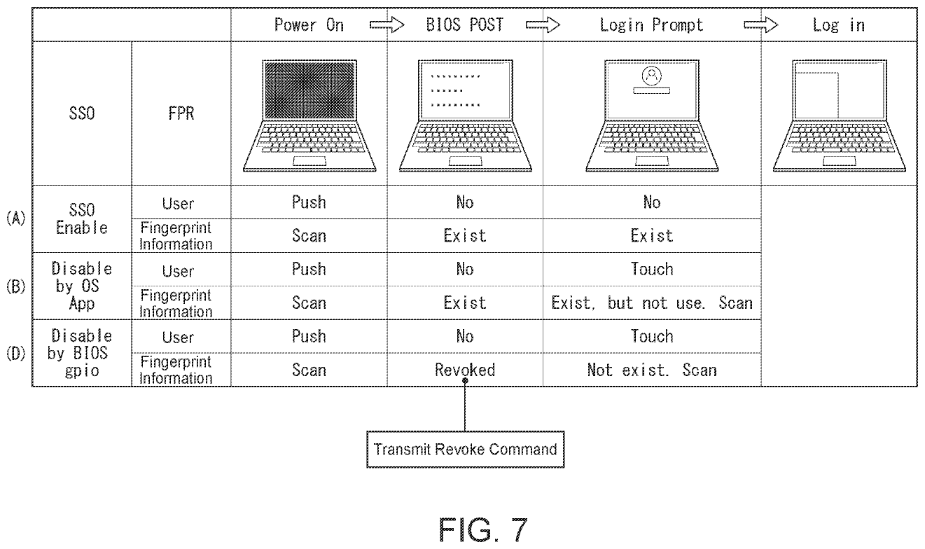

When the SSO is set to disable, the information processing apparatus 10 according to the present embodiment scans a fingerprint once and acquires and holds the fingerprint information in response to the operation of the power button 140. The present embodiment is different from the first embodiment in that the held fingerprint information is revoked before the execution of system authentication processing (e.g., login authentication processing). Referring to FIGS. 7 to 9, the following describes this embodiment in details.

FIG. 7 describes an example of control when SSO is enabled and disabled in the present embodiment. Similar to FIG. 2, this drawing illustrates an example of control during the period from the power on to the system login. Note that (A) and (B) of FIG. 7 are the same as (A) and (B) of FIG. 2. In FIG. 7, (A) indicates an example of control when SSO is set to enable in this embodiment, which is the same control as in the first embodiment. In FIG. 7, (B) indicates an example of conventional control when SSO is set to disable for comparison with the present embodiment.

In FIG. 7, (D) indicates an example of control when SSO is set to disable in this embodiment, and this control differs from the first embodiment. Also when SSO is set to disable, the information processing apparatus 10 scans a fingerprint of the user who pushed the power button 140 in response to the user's pushing of the power button 140 to acquire and hold the fingerprint information. After that, the information processing apparatus 10 transmits a revoke command for revoking the fingerprint information from the BIOS during the POST processing of the BIOS, thus revoking the held fingerprint information.

Thus, the information processing apparatus 10 subsequently boots the OS and transitions to the login screen (display of the login prompt), where no fingerprint information is held and exists. When the user touches (not pushes, but touches to have the fingerprint scanned) the power button 140 again on the login screen, the information processing apparatus 10 scans the user's fingerprint to acquire the fingerprint information. If the fingerprint authentication is successful, the apparatus logs in to the OS. In this way, in the present embodiment, when SSO is disabled, the fingerprint is once scanned in response to the operation of the power button 140, and the fingerprint information is revoked prior to execution of the authentication processing (e.g., login authentication processing) of the system, thus suppressing a concern that the scanned fingerprint information will be leaked, and enhancing the security.

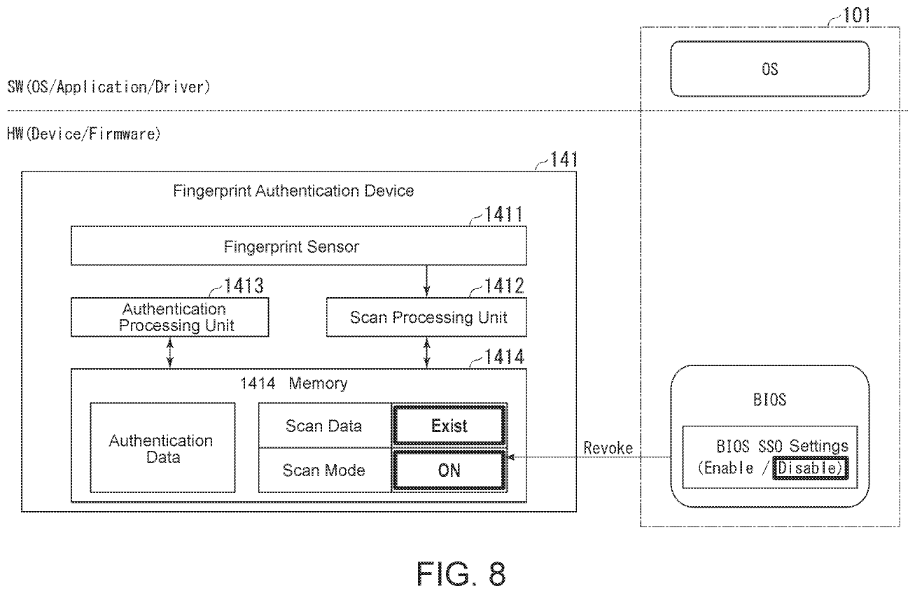

FIG. 8 is a block diagram illustrating one example of the configuration related to finger information acquisition control according to the present embodiment. In FIG. 8, like numerals indicate like components in FIG. 4. In the present embodiment, when SSO is set to enable in the BIOS setting, the scan mode is on and the fingerprint authentication device 141 executes the process of acquiring and holding fingerprint information (scan data) in response to a user's operation of the power button 140 similar to the first embodiment (an example of the first mode).

When SSO is set to disable in the BIOS settings, however, the CPU 101 transmits a revoke command to the fingerprint authentication device 141 while POST processing is being executed by BIOS processing. Receiving the revoke command from the CPU 101, the fingerprint authentication device 141 revokes the held fingerprint information (scan data) (an example of the second mode).

That is, when SSO is set to enable in the BIOS settings, the fingerprint authentication device 141 has fingerprint information (scan data) at the time the authentication process for OS login is executed by the CPU 101. In contrast, when SSO is set to disable, although the fingerprint information is obtained once in response to the operation of the power button 140, no fingerprint information (scan data) exists at the time when the authentication process for OS login is executed. In the present embodiment, the fingerprint information is acquired in either mode in response to the operation of the power button 140 (because the scan mode is not set to off). This means that the fingerprint authentication device 141 does not need to have the function to switch the scan mode between on and off.

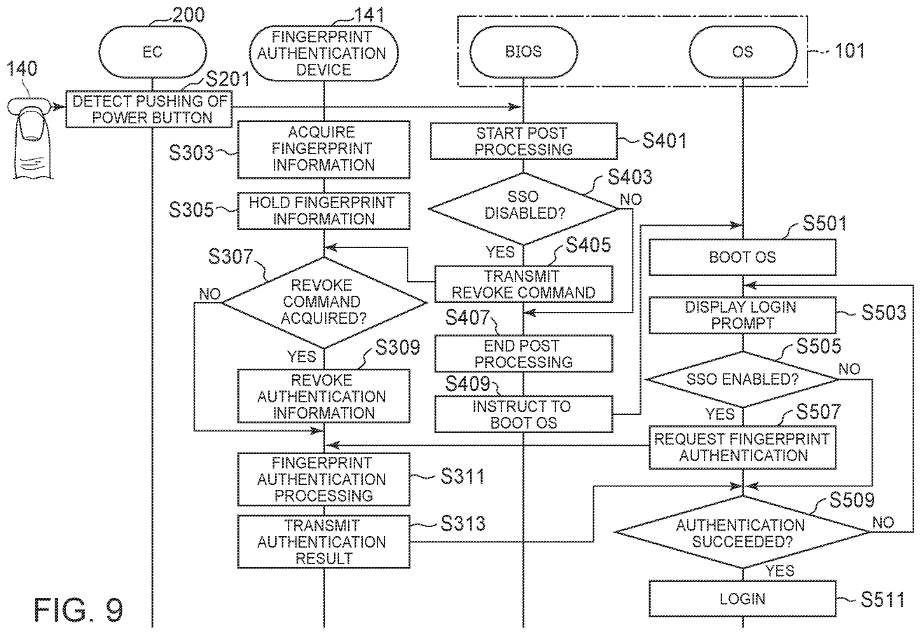

Referring next to FIG. 9, the following describes the operation of fingerprint authentication control processing in the information processing apparatus 10 when the SSO is enabled and disabled. FIG. 9 is a flowchart of one example of the fingerprint authentication control processing according to the present embodiment.

(Step S201) When the user pushes the power button 140, the power button 140 sends an operation signal to the EC 200 in accordance with the user operation (e.g., pushing). When the EC 200 acquires the operation signal from the power button 140, it detects the pushing of the power button 140. Then the EC 200 notifies the BIOS executed by the CPU 101 of a boot signal instructing booting of the system.

(Step S301) The fingerprint authentication device 141 determines whether the scan mode is set to on or not, and if the setting of the scan mode is on, the procedure shifts to step S303. When the setting of the scan mode is off, the fingerprint authentication device 141 does not execute the fingerprint scan processing by the fingerprint sensor 1411 (does not acquire fingerprint information).

(Step S303) The fingerprint authentication device 141 scans the fingerprint of the user who pushed the power button 140 with the fingerprint sensor 1411 to acquire fingerprint information. Then the procedure shifts to step S305.

(Step S305) The fingerprint authentication device 141 stores the fingerprint information (scan data) acquired in step S303 in the memory 1414.

(Step S401) When acquiring the boot signal from the EC 200, the CPU 101 boots the BIOS and starts power on self-test (POST) processing. If SSO is set to disable (step S403: YES), the CPU 101 proceeds to step S405, and if SSO is set to enable (step S403: NO), the CPU 101 proceeds to step S407.

(Step S405) The CPU 101 executes the BIOS processing to transmit a revoke command to the fingerprint authentication device 141 during the POST processing.

(Step S307) The fingerprint authentication device 141 determines whether or not it has acquired a revoke command. If the fingerprint authentication device 141 determines that it has acquired a revoke command (YES), the fingerprint authentication device 141 executes step S309. If the fingerprint authentication device 141 has not acquired a revoke command (NO), it does not execute the process in step S309.

(Step S309) The fingerprint authentication device 141 revokes (deletes from the memory 1414) the fingerprint information held in step S305.

(Step S407) When the POST processing by the BIOS ends, the CPU 101 proceeds to step S409.

(Step S409) The CPU 101 instructs the BIOS to boot the OS.

The subsequent processes from the OS boot to the login authentication in steps S501 to S511 and steps S311 to S313 are the same as those in FIG. 6, and description thereof is omitted.

### Summary of the Second Embodiment

As described above, in the information processing apparatus 10 according to the present embodiment, the fingerprint authentication device 141 has a first mode that holds fingerprint information and a second mode that does not hold fingerprint information at the timing when the authentication processing by the system is executed by the CPU 101. In this embodiment, the fingerprint authentication device 141 (an example of a fingerprint information acquisition unit) acquires and holds fingerprint information in response to the operation of the power button 140 in both the first mode and the second mode. In the second mode, however, once the fingerprint information is held, the held fingerprint information is revoked prior to the timing when the system authentication processing (e.g., login authentication processing) is executed by the CPU 101.

This allows the information processing apparatus 10, which has the configuration of the power button 140 integrated with the fingerprint sensor 1411, to switch between the mode of holding the fingerprint information and the mode of not holding the fingerprint information when the authentication processing by the system is executed, thereby enhancing the security.

In accordance with the BIOS settings (e.g., SSO is disabled), the CPU 101 transmits a revoke command (an example of a control signal instructing to revoke fingerprint information) to the fingerprint authentication device 141 during the POST processing executed by the BIOS in response to the operation of the power button 140. In the second mode, the fingerprint authentication device 141 acquires the revoke command from the CPU 101, and accordingly revokes the held fingerprint information.

In this way, when fingerprint information is not needed, the information processing apparatus 10 enables revoking of the acquired fingerprint information prior to the boot of the OS by changing the BIOS setting, and thus enhances the security.

The information processing apparatus 10 also includes the EC 200 (embedded controller) that instructs the CPU 101 to boot the system in response to the operation of the power button 140. In accordance with the BIOS settings (e.g., SSO is disabled), the EC 200 sends a revoke command to the fingerprint authentication device 141 prior to the timing when the system authentication process (e.g., login authentication processing) is performed by the CPU 101. In the second mode, receiving the control signal from the EC 200, the fingerprint authentication device 141 may revoke the held fingerprint information.

This also allows the information processing apparatus 10 to transmit a revoke command from the EC 200 instead of the BIOS, so as to revoke the fingerprint information when it is not needed prior to the OS boot.

The control method for the information processing apparatus 10 according to the present embodiment includes: a step in which the fingerprint authentication device 141 acquires and holds fingerprint information in response to the operation of the power button 140 in the first and second modes, and a step in which after holding the fingerprint information, the fingerprint authentication device 141 revokes the held fingerprint information in the second mode prior to the timing when the system authentication processing (e.g., login authentication processing) is executed by the CPU 101.

This allows the information processing apparatus 10, which has the configuration of the power button 140 integrated with the fingerprint sensor 1411, to switch between the mode of holding the fingerprint information and the mode of not holding the fingerprint information when the authentication processing by the system is executed, thereby enhancing the security.

This embodiment describes an example of sending a revoke command to the fingerprint authentication device 141 during the POST processing. In another embodiment, a revoke command may be sent to the fingerprint authentication device 141 during the period from the operation of the power button 140 to the system authentication process (e.g., login authentication process) and other than the period of the POST processing.

That is detailed descriptions on the embodiments of the present invention with reference to the drawings. The specific configuration of the present invention is not limited to the above-described embodiments, and also includes design modifications or the like within the scope of the present invention. The configurations described in the above embodiments can be combined freely.

The above embodiments describe an example in which the fingerprint authentication device 141 executes the fingerprint authentication processing in response to receiving a request signal from the OS that requests execution of the fingerprint authentication process, but the present invention is not limited to this. For instance, the fingerprint authentication device 141 may perform the fingerprint authentication process and store the authentication result without waiting for a fingerprint authentication request from the OS, and may return the authentication result in response to receiving a request signal from the OS that requests execution of the fingerprint authentication process. In this case, when receiving a revoke command, the fingerprint authentication device 141 may revoke both the fingerprint information (scan data) and the authentication result.

The above-stated information processing apparatus 10 internally includes a computer system. A program to implement the functions of various configurations of the information processing apparatus 10 as stated above may be stored in a computer-readable recording medium, and the processing at the various configurations of the information processing apparatus 10 may be performed by causing the computer system to read and execute the program stored in this recording medium. “Causing the computer system to read and execute the program stored in the recording medium” includes installing of such a program in the computer system. The “computer system” here includes an OS and hardware, such as peripherals. The “computer system” may include a plurality of computer devices connected via a network, including the internet and communication lines, such as WAN, LAN and dedicated lines. The “computer readable recording medium” is a portable medium, such as flexible disk, a magneto-optical disc, a ROM, or a CD-ROM, as well as a memory internally stored in the computer system, such as hard disk. In this way, the recording medium to store the program may be a non-transient recording medium, such as a CD-ROM.

The recording medium also includes an internal or external recording medium where a distribution server can access to distribute the program. The program may be divided into a plurality of pieces. After these pieces of program may be downloaded at different timings, they may be combined by the configurations of the information processing apparatus 10. Alternatively, different distribution servers may distribute these divided pieces of program. The “computer readable recording medium” also includes the one that can hold a program for a certain period of time, as in a server that receives a program transmitted via a network or a volatile memory (RAM) in the computer system as the client. The program may implement a part of the functions as stated above. The program may be a differential file (differential program) that can implement the above functions by combining it with a program which is already stored in the computer system.

A part or all of the functions that the information processing apparatus 10 of the above-described embodiments has may be implemented as an integrated circuit, such as a LSI (Large Scale Integration). Each of the functions as stated above may be implemented as one processor, or a part or all of the functions may be implemented as one processor in an integrated manner. A technique for integrated circuit is not limited to a LSI, and an integrated circuit may be implemented using a dedicated circuit or a general-purpose processor. If a technique for integrated circuit that replaces LSIs becomes available with the development of semiconductor techniques, an integrated circuit based on such a technique may be used.

Instead of the laptop PC, the information processing apparatus 10 may be of other types, such as a desktop PC, a tablet terminal, and a smartphone.

### DESCRIPTION OF SYMBOLS

10 information processing apparatus
100 system processing unit
101 CPU
102 GPU
103 chipset
104 system memory
110 display unit
120 communication unit
130 storage unit
140 power button
141 fingerprint authentication device
1411 fingerprint sensor
1412 scan processing unit
1413 authentication processing unit
1414 memory
150 input device
151 keyboard
153 touchpad
200 EC
300 power supply unit

What is claimed is:

1. An information processing apparatus comprising:
a fingerprint authentication device that acquires and holds fingerprint information of a finger operating a power button with a fingerprint sensor that is integrated with the power button to boot a system; and
a processor that executes authentication processing by the system based on the fingerprint information acquired by the fingerprint authentication device, and
the fingerprint authentication device having, at a time when authentication processing by the system is executed by the processor, a first mode that holds the fingerprint information and a second mode that does not hold the fingerprint information.

2. The information processing apparatus according to claim 1, wherein the fingerprint authentication device in the first mode executes a process of acquiring and holding the fingerprint information in response to an operation of the power button, and the fingerprint authentication device in the second mode does not execute a process of acquiring the fingerprint information in response to an operation of the power button.

3. The information processing apparatus according to claim 2, wherein
when the system transitions to a standby or stop state and the second mode is set, the fingerprint authentication device does not execute a process of acquiring the fingerprint information in response to a next operation of the power button.

4. The information processing apparatus according to claim 3, wherein
in accordance with basic input output system (BIOS) settings, the processor executes a BIOS processing to send a control signal to set the fingerprint authentication device to the second mode when the system transitions to a standby or stop state.

5. The information processing apparatus according to claim 3, further comprising an embedded controller that instructs the processor to boot the system in response to an operation of the power button, wherein
in accordance with basic input output system (BIOS) settings, the embedded controller sends a control signal to set the fingerprint authentication device to the second mode when the system transitions to a standby or stop state.

6. The information processing apparatus according to claim 2, wherein
when the system transitions to a standby or stop state and the first mode is set, the fingerprint authentication device acquires and holds the fingerprint information in response to a next operation of the power button.

7. The information processing apparatus according to claim 1, wherein
in both the first mode and the second mode, the fingerprint authentication device acquires and holds the fingerprint information in response to an operation of the power button, and in the second mode, after holding the fingerprint information, the fingerprint authentication device revokes the held fingerprint information prior to the time when authentication processing of the system is executed by the processor.

8. The information processing apparatus according to claim 7, wherein
in accordance with basic input output power system (BIOS) settings, the processor sends a control signal to instruct the fingerprint authentication device to revoke the fingerprint information during a period of power on self-test (POST) executed by BIOS in response to an operation of the power button, and
in the second mode, in response to acquisition of the control signal from the processor, the fingerprint authentication device revokes the held fingerprint information.

9. The information processing apparatus according to claim 7, further comprising an embedded controller that instructs the processor to boot the system in response to an operation of the power button, wherein
in accordance with basic input output system (BIOS) settings, the embedded controller sends a control signal to instruct the fingerprint authentication device to revoke the fingerprint information prior to the time when authentication process of the system is executed by the processor, and
in the second mode, in response to acquisition of the control signal from the embedded controller, the fingerprint authentication device revokes the held fingerprint information.

10. A control method for an information processing apparatus including: a fingerprint authentication device that acquires and holds fingerprint information of a finger operating a power button with a fingerprint sensor that is integrated with the power button to boot a system; and a processor that executes authentication processing by the system based on the fingerprint information acquired by the fingerprint authentication device, the method comprising:
a step in which the fingerprint authentication device sets to a first mode or a second mode in accordance with an incoming control signal when the system transitions to a standby or stop state; and
a step in which the fingerprint authentication device acquires and holds the fingerprint information in response to a next operation of the power button only when the first mode is set between the first and second modes.

11. A control method for an information processing apparatus including: a fingerprint authentication device that acquires and holds fingerprint information of a finger operating a power button with a fingerprint sensor that is integrated with the power button to boot a system; and a processor that executes authentication processing by the system based on the fingerprint information acquired by the fingerprint authentication device, the method comprising:
a step in which the fingerprint authentication device acquires and holds the fingerprint information in response to an operation of the power button in first and second modes, and
a step in which, after holding the fingerprint information, the fingerprint authentication device in the second mode revokes the held fingerprint information prior to a time when authentication process of the system is executed by the processor.
